(19) United States
(12) Patent Application Publication
(10) Pub. No.: US 2025/0205702 A1
(43) Pub. Date: Jun. 26, 2025

(54) DROPLET FORMATION SYSTEM

(71) Applicant: SPHERE FLUIDICS LIMITED, Cambridge (GB)

(72) Inventors: John S MCGRATH, Cambridge, Cambridgeshire (GB); Clive A. SMITH, Cambridge, Cambridgeshire (GB); Graeme WHYTE, Cambridge, Cambridgeshire (GB); Dimitris JOSEPHIDES, Cambridge, Cambridgeshire (GB); Xin LI, Cambridge, Cambridgeshire (GB); Andrea VENTURA, Cambridge, Cambridgeshire (GB); William WHITLEY, Cambridge, Cambridgeshire (GB)

(21) Appl. No.: 18/848,159

(22) PCT Filed: Mar. 17, 2023
(86) PCT No.: PCT/EP2023/056960

§ 371 Date: Sep. 18, 2024

(30) Foreign Application Priority Data
Mar. 18, 2022 (GB) 2203849.1

(51) Int. Cl. B01L 3/00

(52) U.S. Cl. CPC B01L 3/50273; B01L 2200/0605; B01L 2200/061; B01L 2300/0663; B01L 2300/087; B01L 2300/0883; B01L 2400/0487

(57) ABSTRACT

A method and system for determining droplet frequency of a flow of microfluidic droplets within a microfluidic droplet channel, comprising illuminating the flow of microfluidic droplets, using a beam splitter to split light from the flow of microfluidic droplets into a first portion and a second portion, directing the first portion to a camera, directing the second portion through an aperture located in front of a photodetector to the photodetector, and processing a signal from the photodetector and determining a droplet frequency from fluctuations in the processed signal. The method may be used to determine droplet dimension. The method may also be used to adjust a pressure of a flow of droplet fluid in response to a determined droplet dimension to generate a flow of droplets.

### TECHNICAL FIELD

The present application relates to systems and methods for determining droplet frequency of a flow of microfluidic droplets, particular but not exclusively, the present application further relates to systems and methods for determining and controlling a droplet dimension.

### BACKGROUND

In this specification we are concerned with emulsions, typically comprising picodroplets of water in oil, generally surfactant-stabilised. One or more biological entities such as one or more living cells or particles may be incorporated into each droplet and then experiments performed within the droplet, for example to perform a biological assay.

Picodroplets can be generated and processed potentially at rates in excess of several thousand per second.

Typically, the oil composition comprises a fluorous and/or mineral oil and/or silicone oils, preferably, a surfactant, for example at around 0.5-5% vol/vol. Use of a fluorous oil is particularly advantageous when the microdroplets contain living entities because fluorous oil is good at transporting oxygen to the microdroplets. The surfactant may be either polymeric or small molecule; for example, surfactants derived from block co-polymers of perfluoroethers such as Krytox® or polyethylene glycol (PEG) may be used. The material or analyte within a microdroplet may comprise, for example, cells, DNA, protein, peptide, beads, particles, crystals, micelles, macromolecules, material for an enzymatic assay, organelles, an organism such as cell for example a mammalian cell, yeast cell, algal cell or bacterium, a virus, a prion and so forth.

Crawford, D. F., Smith, C. A. & Whyte, G. Image-based closed-loop feedback for highly mono-dispersed microdroplet production. Sci Rep 7, 10545 (2017). relates to controlling the size of microdroplets. US2011/000560, US2014/354795, and US2021/146319 relate to using a camera for determining droplet frequency.

### SUMMARY

Aspects and preferred features are set out in the accompany claims.

According to a first aspect there is provided a method of determining droplet frequency of a flow of microfluidic droplets within a microfluidic droplet channel, the method comprising:
illuminating the flow of microfluidic droplets within the microfluidic droplet channel;
using a beam splitter to split light from the flow of microfluidic droplets into a first portion and a second portion, wherein the first portion comprises light above a predetermined threshold wavelength and wherein the second portion comprises light below a predetermined threshold wavelength;
directing the first portion to a camera;
directing the second portion through an aperture located in front of a photodetector to the photodetector;
processing a signal from the photodetector and determining a droplet frequency from fluctuations in the processed signal.

Processing the signal from the photodetector may comprise obtaining and processing a photodetector output voltage signal over a given time period to identify voltage signal differences which correspond with differences in optical characteristics exhibited at interfaces between carrier fluid and droplets as droplets pass a detection region of the microfluidic droplet channel.

The herein disclosed method provides an automated method of determining droplet frequency of a flow of microfluidic droplets. By directing the second portion through an aperture located in front of a photodetector, the sensitivity of the photodetector is improved.

The method may further comprise detecting a droplet using the processed signal, and upon detection of the droplet, simultaneously capturing an image of the droplet using the camera. This uses the output of the detected photodetector signal to actively trigger the camera, via a microprocessor, to automatically image droplets within the microfluidic channel.

The microprocessor camera triggering algorithm may further allow the individual droplet detection incidences to be counted over a set period of time, or until the last image was captured, to establish droplet frequency.

The method may further comprise determining a droplet dimension from the captured image of the droplet.

The method may further comprise calculating a droplet volume from the determined dimension.

The term dimension may be herein used to refer to a physical width or length of the droplet within a microfluidic droplet channel.

In an example, the droplet can be considered to be spherical and the determined dimension can be the radius of the sphere. The spherical droplet volume may then be calculated using the determined radius.

In an alternative example, at least one droplet dimension (e.g. a width of the droplet) may be limited by a known width or cross-sectional area of the microfluidic channel and a second droplet dimension may be determined using the method as described above (e.g. a length of the droplet within the droplet channel). The droplet volume may be calculated using the known width or cross-sectional area and the determined droplet dimension.

The method of determining the droplet dimension may comprise identifying sidewalls of the microfluidic droplet channel and centres of droplets within the image of the flow, determining an interest region in captured images of droplets, wherein the interest region comprises a line region comprising a droplet centre and wherein the interest region is parallel to the sidewalls, and determining the droplet dimension by processing the line region of the image. The interest region may also comprise two opposite points on the outside surface of the droplet.

The method may comprise comparing the size (e.g. number of pixels) of the processed line region between the sidewalls against a known size of each pixel within the processed line region. The known size of each pixel could alternatively be termed as the number of pixels required to display a given physical length. In other words, the physical length or size of the interest region can be determined by knowing the number of pixels per inch (or per centimeter) in the captured image. This resolution of the captured image can be determined by knowing the resolution of the sensor or camera together with the dimension of field of view.

Alternatively, the physical size can be estimated or calculated using a known physical distance between the camera and the droplet, the focal length of the camera, the number of pixels within the line region, and the pixel pitch of the camera.

The captured images of the microfluidic flow may be processed to identify microchannel geometrical features and the centre of produced droplets. This may be an automated method performed on a processor. The method can then subsequently define a line region of interest which is parallel to the microchannel sidewalls and intersects imaged droplets rough their centre to obtain a measure of droplet diameter for subsequent use as the input to a closed-loop image-based feedback routine, which regulates the monodispersity of a produced emulsion.

Alternatively, or additionally, the method of determining the droplet dimension may comprise comparing a dimension of the droplet within the captured image with a marker of a known size and located within the microfluidic channel. This provides a simpler method of measuring the droplet dimension, and improves the accuracy of the determined droplet dimension.

According to a further aspect of the disclosure, there is provided a method of determining a total volume of fluid within a sequence of droplets within a flow of microfluidic droplets comprising:
determining droplet frequency of the flow of microfluidic droplets within a microfluidic droplet channel using a method as described above;
for each droplet within the flow of microfluidic droplets, calculating a droplet volume;
calculating an average droplet volume of the droplets; and
determining a total volume of droplets using the droplet frequency and the average droplet volume.

Calculating a droplet volume for each droplet within the flow of microdroplets may comprise calculating a droplet volume for each imaged droplet within the flow. The method may comprise only imaging a proportion of the droplets within the flow, and therefore the droplet volume will not be calculated for droplets that are not imaged.

Calculating the average droplet volume may comprise calculating a rolling average of droplet volume of imaged droplets, and may include the most recent imaged droplets.

Determining a total volume of droplets may comprise determining a total volume of droplets over a given time period.

According to a further aspect of the disclosure, there is provided a method of generating a flow of droplets comprising
providing a first droplet fluid;
providing a carrier fluid;
forming an emulsion of droplets comprising the first droplet fluid within the carrier fluid, by providing a flow of said first droplet fluid and a flow of said carrier fluid to a droplet generation region of a microfluidic structure;
determining a total volume of fluid within a sequence of droplets within the emulsion of droplets using a method as described above; and
increasing a pressure of the flow of the carrier fluid line in response to a determined total volume of fluid within the sequence of droplets being greater than a predetermined threshold value to inhibit droplet generation. In this way, the user can specify the volume of emulsion that they want to collect, based on the sample size provided, and the machine will stop producing the emulsion when this value is achieved.

According to a further aspect of the disclosure, there is provided a method of generating a flow of droplets comprising:
providing a first droplet fluid;
providing a carrier fluid;
forming an emulsion of droplets comprising the first droplet fluid within the carrier fluid, by providing a flow of said first droplet fluid and a flow of said carrier fluid to a droplet generation region of a microfluidic structure;
determining droplet dimension of sequential droplets within the emulsion using a method as described above; and
adjusting a pressure of the flow of the first droplet fluid and/or a pressure of the flow of said carrier fluid in response to the determined droplet dimension.

This provides semi-automated droplet generation with real-time droplet frequency determination, size calculation, and triggered closed-loop image-based feedback control of droplet monodispersity. The method maintains the monodispersity of the flow of droplets by controlling the pressure of the flow of the first droplet fluid or the flow of said carrier fluid in response to the determined droplet dimension.

The method of generating a flow of droplets may comprise varying a pressure of the flow of the first droplet fluid and varying a pressure of the flow of said carrier fluid upon such that a determined droplet dimension is substantially constant between sequential droplets.

The herein disclosed method can be scaled up to provide a plurality of parallelized droplet generation regions on a microfluidic chip. Photodetector-based detection of the presence of individual droplets can be used to initiate the triggered capturing of droplet images at two or more specified areas within a microfluidic chip containing the plurality of parallelized droplet generation regions. Droplet size data from one or more regions of interest may be used as an input for a closed-loop image-based feedback routine which regulates the monodispersity of the emulsion produced from the microfluidic chip. The use of a parallel droplet generator chip allows accurate droplet volume control across a plurality of microfluidic channels for ultra-high throughput droplet generation.

During a starting time period of the method of generating a flow of droplets, the method may comprise directing the flow of droplets to a waste channel in response to said determined droplet dimension being outside a predetermined droplet dimension range. When the instrument is started-up, there may be a period of time where the droplets that are being generated do not meet the specified user's size requirements. Whilst the droplets that are being generated do not meet the specified user's size requirements, this would allow these droplets to travel to the waste channel.

When the correct droplet size is achieved, droplets may be prevented from going to waste and instead may be collected. This may be performed by closing a valve on the waste channel. The valve may be programmed to close over a predetermined time period. By closing the valve of the waste channel relatively slowly, this allows the system to compensate for the increased back pressure in the system without the droplet volume changing.

According to a further aspect of the disclosure, there is provided a method of generating a flow of droplets comprising:
providing a first droplet fluid;
providing a carrier fluid;
providing a second droplet fluid;
forming an emulsion of droplets comprising a mixture of the first droplet fluid and the second droplet fluid within the carrier fluid, by providing a flow of said first droplet fluid and a flow of said second droplet fluid and a flow of said carrier fluid to a droplet generation region of a microfluidic structure;
measuring a flow rate of the flow said first droplet fluid or the flow of said second droplet fluid;
determining a total volume of fluid within droplets within the emulsion of droplets using a method as described above;
determining a ratio of the first droplet fluid and the second droplet fluid within the mixture using the measured flow rate and the total volume of droplets; and
adjusting a pressure of the flow of the first droplet fluid or the flow of the second droplet fluid in response to the determined ratio.

The use of the image-based determination droplet volume and photodetector-based determination of the total aqueous flow rate, plus the use of a flow sensor at one of two droplet fluid inlets, allows the production of monodisperse dual-aqueous droplets having a defined mixture ratio between the two aqueous flows.

The flow sensor may preferably be configured to measure the flow rate of the second droplet fluid, as the first droplet fluid may contain cells or fragile biological or chemical components.

This method can also be used to maintain or control the cell occupancy in the production of monodisperse droplets formed of two droplet fluids: one of which including cells or particles, and the other being a diluent.

According to a further aspect of the disclosure, there is provided a method for generating a flow of droplets, comprising:
providing n droplet fluids;
providing a carrier fluid;
forming an emulsion of droplets comprising a mixture of the n droplet fluids within the carrier fluid, by providing a flow of each of the n droplet fluids and a flow of said carrier fluid to a droplet generation region of a microfluidic structure;
measuring a flow rate of n−1 flows of droplet fluids;
determining a total volume of fluid within droplets within the emulsion of droplets a method as described above;
determining a ratio of the n droplet fluids within the mixture using the n−1 measured flow rates and the total volume of droplets; and
adjusting a pressure of one or more of the n flows of droplet fluids in response to the determined ratio.

According to a further aspect of the disclosure, there is provided a microfluidic system comprising:
a microfluidic droplet channel to carry a flow of microfluidic droplets;
a light source to illuminate the flow of microfluidic droplets with a beam of light comprising light having a range of wavelengths both above and below a predetermined threshold wavelength;
a beam splitter configured to split light from the flow of microfluidic droplets into a first portion and a second portion, wherein the first portion comprises light above the predetermined threshold wavelength and wherein the second portion comprises light below the predetermined threshold wavelength;
a camera configured to receive the first portion of the light;
a photodetector configured to receive the second portion of the light, wherein an aperture is located in front of the photodetector;
apparatus configured to process a signal from the photodetector; and
a processor configured to determine a droplet frequency from fluctuations in the processed signal.

The processor may be configured to detect a droplet using the processed signal, and the camera may be configured to simultaneously capture an image of the droplet upon the detection of a droplet.

The camera may have an exposure time of 1 us or less. This provides a high-speed area scanning camera, which can capture an image of a droplet in a microfluidic channel.

The system may comprise a first droplet fluid line to carry a first droplet fluid, a carrier fluid line to carry a carrier fluid, and a droplet generation region having a first input to receive a flow from the first droplet fluid line, having a second input to receive a flow from the carrier fluid line, and having an output to the microfluidic droplet channel. The processor may be configured to determine an average droplet volume using captured images of droplets. The processor may be further configured to determine a total volume of droplets within a sequence of droplets within the flow of microfluidic droplets using the average droplet volume and the droplet frequency. The system may further comprise means for increasing a pressure in the carrier fluid line in response to a determined total volume of droplets being greater than a predetermined threshold value.

The system may comprise a first droplet fluid line to carry a first droplet fluid, a carrier fluid line to carry a carrier fluid, and a droplet generation region having a first input to receive a flow from the first droplet fluid line, having a second input to receive a flow from the carrier fluid line, and having an output to the microfluidic droplet channel. The processor may be configured to determine a droplet dimension of sequential droplets using captured images of droplets. The system may further comprise means for adjusting a pressure in the carrier fluid line or the first droplet fluid in response to the determined droplet dimension.

The system may comprise n droplet fluid lines each configured to carry one of n droplet fluids, a carrier fluid line to carry a carrier fluid, and a droplet generation region having n inputs to receive n flows from the n droplet fluid lines, having a further input to receive a flow from the carrier fluid line, and having an output to the microfluidic droplet channel, such that the droplet generation region forms an emulsion of droplets comprising a mixture of the n droplet fluids within the carrier fluid. The system may further comprise n−1 flow rate sensors configured to measure a flow rate of n−1 flows of the n flows of droplet fluids. The processor may be configured to determine an average droplet volume using captured images of droplets. The processor may be further configured to determine a total volume of droplets within a sequence of droplets within the flow of microfluidic droplets using the average droplet volume and the droplet frequency. The processor may be further configured to determine a ratio of the n droplet fluids within the mixture using the n−1 measured flow rates and the total volume of droplets. The system may further comprise means for adjusting a pressure of one or more of the n flows of droplet fluids in response to the determined ratio.

The aperture may comprise a slit corresponding to a band of light substantially perpendicular to sidewalls of the microfluidic droplet channel.

Alternatively, the aperture may comprise a pin-hole corresponding to a beam of light positioned substantially in the centre of the microfluidic droplet channel.

The aperture may comprise a mechanical slit which allows only a narrow band of light, perpendicular to the main microfluidic channel sidewalls, to reach the photodetector, and thus, increases detection sensitivity.

Alternatively, the aperture may comprise a crescent aperture configured to increase sensitivity of the photodetector.

The first portion may comprise light having a wavelength greater than 488 nm and the second portion may comprise light having a wavelength less than 488 nm.

The droplets may be microdroplets, nanodroplets, or picodroplets, or may be larger or smaller.

According to a further aspect of the disclosure, there is provided a microfluidic method of preparing a droplet, the method comprising:
providing a flow of an emulsion of microfluidic droplets of a first droplet fluid within a carrier fluid in a microfluidic channel;
determining a droplet dimension of a droplet in the flow of microfluidic droplets;
providing a flow of a second droplet fluid to the microfluidic channel;
fusing the droplet of the first droplet fluid with at least a portion of the second droplet fluid to obtain a fused droplet;
determining a droplet dimension of the fused droplet; and
adjusting a pressure or flow rate of the flow of the emulsion of microfluidic droplets and/or a pressure or flow rate of the flow of the second droplet fluid in response to the determined fused droplet dimension.

The volume of individual microfluidic droplets of a first droplet fluid or the volume of second droplet fluid fused with the microfluidic droplets of a first droplet fluid can be controlled using closed-loop image-based feedback.

The method allows the use of closed-loop image-based feedback to regulate the volume ratio of individual microfluidic droplets which are comprised of a mixture of two or more droplet fluids.

The method may be used to prepare droplets having a constant and regulated droplet volume or volume ratio of constituent parts, or may be used to adjust a droplet volume or volume ratio of constituent parts to a desired or predetermined value.

The method may be used to produce fused droplets having two or more constituent parts or containing a mixture of two or more fluids. The method may use an image of a droplet of first droplet fluid captured before fusing the droplet of a first droplet fluid with the second droplet fluid, and an image of a fused droplet captured after fusing the droplet of a first droplet fluid with the second droplet fluid to calculate the volume of each fluid constituent part within an individual fused drop. The calculated volume of the constituent part, or a ratio of volumes of constituent parts, may then be used as an input to a closed-loop feedback system which may produce a monodisperse emulsion of fused droplets.

The emulsion of microfluidic droplets of a first fluid may be provided from an external system or may be prepared on a separate chip that is connected to the chip including the droplet fusion region or may be prepared on a same chip as the droplet fusion region. In examples where the microfluidic droplets of the first fluid are produced on the same chip or on a separate chip that is connected to the chip including the droplet fusion region, the method may include adjusting or regulating the volume of droplets of the first fluid that are produced prior to fusion, rather than reinjected to the chip.

The droplet dimension of the droplet in the flow of microfluidic droplets and/or the droplet dimension of the fused droplet may be determined according to a method of determining a droplet dimension as described above.

Providing a flow of second droplet fluid may comprise providing a flow of second droplet fluid from a fluid inlet arranged on a sidewall of the microfluidic channel.

Fusing the droplet of the first droplet fluid with at least a portion of the second droplet fluid to obtain a fused droplet may comprise forming a fused droplet comprised of a mixture of the first droplet fluid and the second droplet fluid.

The method may further comprise determining a ratio of the first droplet fluid and the second droplet fluid in the mixture of the first droplet fluid and the second droplet fluid. A pressure or flow rate of the flow of emulsion or flow of second droplet fluid may be adjusted in response to the determined ratio.

Fusing the droplet of the first droplet fluid with at least a portion of the second droplet fluid may comprise applying an electric field across the first droplet fluid and a portion of the second droplet fluid. Applying an electric field may cause the droplet to merge with the end of second droplet fluid flow at the junction of the microfluidic channel and the second droplet fluid inlet. This may then break off into fused droplet by the shear force of the carrier fluid in the microfluidic channel.

Providing a flow of an emulsion of microfluidic droplets of a first droplet fluid within a carrier fluid in a microfluidic channel may comprise: providing a first droplet fluid; providing a carrier fluid; and forming an emulsion of droplets comprising the first droplet fluid within the carrier fluid, by providing a flow of said first droplet fluid and a flow of said carrier fluid to a droplet generation region of a microfluidic structure.

Adjusting a pressure or flow rate of the flow of the emulsion of microfluidic droplets may comprise adjusting a pressure of the flow of the first droplet fluid and/or a pressure of the flow of said carrier fluid in response to the determined droplet dimension.

The method may further comprise providing a flow of spacing fluid to the microfluidic droplet channel. Adjusting a pressure or flow rate of the flow of the emulsion of microfluidic droplets may comprise adjusting a pressure or flow rate of the flow of spacing fluid in response to the determined droplet dimension.

According to a further aspect of the disclosure, there is provided a microfluidic system comprising:
a droplet inlet for providing a flow of an emulsion of microfluidic droplets of a first droplet fluid within a carrier fluid;
a droplet sensing system for determining a dimension of a droplet within the flow of microfluidic droplets;
a fluid inlet for providing a flow of a second droplet fluid;
a droplet fusion region having a first input to receive a flow from the droplet inlet and having a second input to receive a flow from the fluid inlet, and configured to fuse the droplet of the first droplet fluid with at least a portion of the second droplet fluid to obtain a fused droplet;
a second droplet sensing system for determining a dimension of the fused droplet; and
means for increasing a pressure or flow rate of the emulsion within the droplet inlet or the second droplet fluid within the fluid inlet in response to the determined dimension of the fused droplet,
The droplet sensing system or the second droplet sensing system may comprise a microfluidic system as described above.

The fluid inlet may be arranged on a sidewall of the microfluidic channel.

The fluid inlet may be substantially perpendicular to the microfluidic channel.

The droplet fusion region may comprise means configured to fuse the droplet of the first droplet fluid with at least a portion of the second droplet fluid.

The means configured to fuse the droplet of the first droplet fluid with at least a portion of the second droplet fluid may comprise a plurality of electrodes configured to provide an electric field across the droplet of the first droplet fluid and a portion of the second droplet fluid.

The microfluidic system may further comprise: a first droplet fluid line to carry a first droplet fluid; a carrier fluid line to carry a carrier fluid; and a droplet generation region having a first input to receive a flow from the first droplet fluid line, having a second input to receive a flow from the carrier fluid line, and having an output to the microfluidic droplet channel.

The microfluidic system may further comprise a spacing fluid line configured to provide a flow of spacing fluid to the microfluidic droplet channel.

According to a further aspect of the disclosure, there is provided a microfluidic method of forming a pair of microdroplets comprising:
providing a flow of an emulsion of microfluidic droplets of a droplet fluid within a carrier fluid in a microfluidic channel;
determining a droplet dimension of a droplet in the flow of microfluidic droplets;
splitting the droplet into a first droplet and a second droplet;
directing the first droplet to a first droplet channel;
directing the second droplet to a second droplet channel;
determining a droplet dimension of the first droplet or the second droplet;
providing a flow of a spacing fluid to the first droplet channel or the second droplet channel; and
adjusting a pressure or flow rate of the flow of the emulsion of microfluidic droplets and/or a pressure or flow rate of the flow of spacing fluid in response to the determined dimension of the first droplet or the second droplet.

Directing the first droplet to the first droplet channel and/or directing the second droplet to the second droplet channel may comprise changing the direction of flow of the first droplet or second droplet. Alternatively, directing the first droplet to the first droplet channel and/or directing the second droplet to the second droplet channel may comprise allowing the first droplet or the second droplet to continue to flow in a same microfluidic channel and/or allow the first droplet or the second droplet to continue to flow in the same direction.

The droplet dimension of the droplet in the flow of microfluidic droplets and/or the droplet dimension of the first droplet and/or the droplet dimension of the second droplet may be determined according to a method as described above.

The volume of two or more individual daughter droplets or the volumetric distribution between two or more individual daughter droplets produced by splitting a larger droplet into two droplets can be controlled using closed-loop image-based feedback.

The method allows the use of closed-loop image based feedback to regulate the volumes of droplets produced by splitting a larger droplet using a droplet splitting mechanism.

The method may be used to prepare two or more daughter droplets each having a constant and regulated droplet volume, or may be used to adjust a droplet volume two or more daughter droplets to desired or predetermined values. The method may be used to maintain the volumes of both the first droplet and the second droplet to be consistent with each other.

The emulsion of microfluidic droplets of may be provided from an external system or may be prepared on a separate chip that is connected to the chip including the droplet splitting region or may be prepared on a same chip as the droplet splitting region. In examples where the microfluidic droplets are produced on the same chip or on a separate chip that is connected to the chip including the droplet splitting region, the method may include adjusting or regulating the volume of droplets that are produced prior to splitting, rather than reinjected to the chip.

The microfluidic method may comprise determining a droplet volume of one of the first droplet or the second droplet, and may further comprise calculating a droplet volume of the other of the first droplet and the second droplet using the previously determined droplet volume of the first droplet or the second droplet and a predetermined volume of the droplet in the flow of microfluidic droplet.

Determining a droplet dimension may comprise capturing an image of a droplet using a droplet sensing system, and determining a droplet dimension from the captured image.

According to a further aspect of the disclosure, there is provided a microfluidic system comprising:
a droplet inlet for providing a flow of an emulsion of microfluidic droplets of a droplet fluid within a carrier fluid;
a droplet sensing system for determining a dimension of a droplet within the flow of microfluidic droplets;
a droplet splitting region having a first input to receive a flow from the droplet inlet and having a first output to a first droplet channel and having a second output to a second droplet channel, wherein the droplet splitting region is configured to split a droplet in the flow of microfluidic droplets into a first droplet and a second droplet;
a fluid inlet for providing a flow of spacing fluid to the first droplet channel or the second droplet channel;
a second droplet sensing system for determining a dimension of the first droplet or the second droplet; and
means for increasing a pressure or flow rate of the emulsion within the droplet inlet or the spacing fluid within the fluid inlet in response to the determined dimension of the first droplet or the second droplet.

The droplet sensing system and/or the second droplet sensing system may comprise a microfluidic system as described above.

The first droplet channel and the second droplet channel may have different cross-sectional areas. This allows different sized daughter droplets to be produced.

Alternatively, the first droplet channel and the second droplet channel may have substantially the same cross-sectional areas.

The microfluidic system may further comprise a spacing fluid line configured to provide a flow of spacing fluid to the droplet inlet.

The droplet sensing system and/or the second droplet system comprise a camera configured to capture an image of a droplet and means for determining a droplet dimension from the captured image of the droplet.

### BRIEF DESCRIPTION OF THE DRAWINGS

Some embodiments of the disclosure will now be described, by way of example only and in reference to the accompanying drawings, in which:

FIG. 1 illustrates schematically an optical assembly for imaging a microfluidic chip;

FIG. 2 shows an example of the optical assembly of FIG. 1;

FIG. 3 illustrates schematically a region of interest in a captured image of a droplet within a microfluidic channel;

FIG. 4 illustrates schematically a droplet generation region;

FIG. 5 illustrates schematically a flow focus junction and Y-junction within the droplet generation region shown in FIG. 4;

FIG. 6 illustrates schematically a droplet generation region for producing an emulsion of dual-aqueous droplets;

FIG. 7 illustrates schematically a flow focus junction and Y-junction within the droplet generation region shown in FIG. 6;

FIG. 8 shows an example droplet fusion region;

FIG. 9 illustrates schematically a droplet reinjection region and droplet fusion region;

FIG. 10 illustrates schematically the droplet fluid inlet of the droplet fusion region shown in FIG. 9;

FIG. 11 illustrates schematically a droplet generation region and droplet fusion region;

FIG. 12 illustrates schematically the droplet fluid inlet of the droplet fusion region shown in FIG. 11;

FIG. 13 illustrates schematically a droplet reinjection region and a droplet splitting region; and

FIG. 14 illustrates schematically a droplet splitting region, such as that shown in FIG. 13.

### DETAILED DESCRIPTION OF PREFERRED EMBODIMENTS

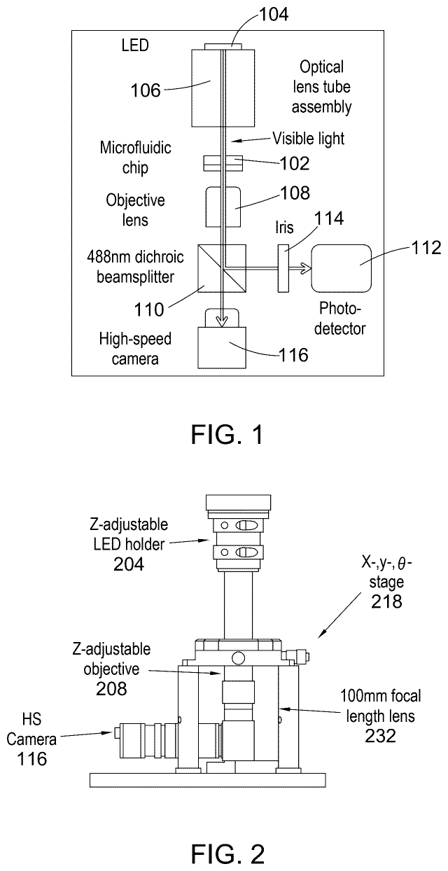

FIG. 1 illustrates schematically an optical assembly for imaging a microfluidic chip, and FIG. 2 shows a side view of an example of the optical assembly of FIG. 1.

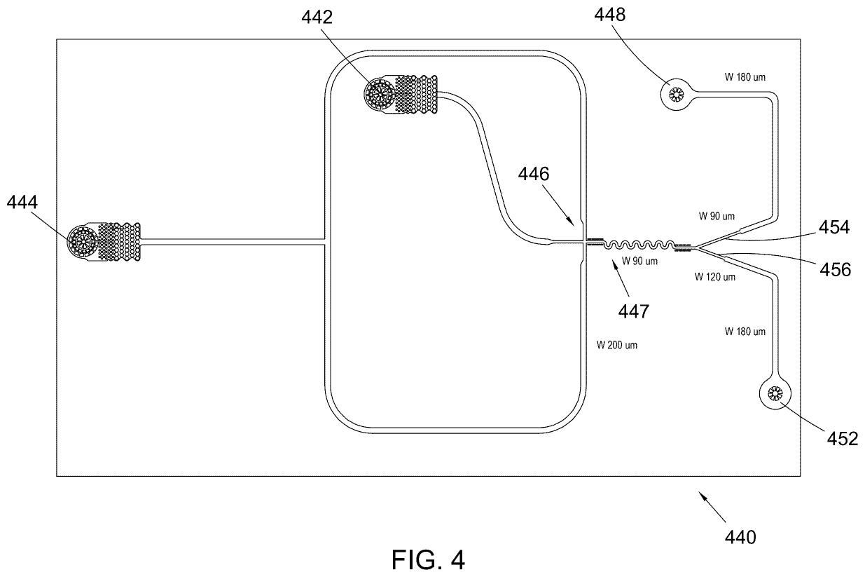

The optical assembly includes a microfluidic chip 102 having a microfluidic channel carrying a flow of microfluidic droplets. The droplets may be generated using the systems shown in FIGS. 4 to 6. An LED 104 attached to an optical lens tube assembly 106 is configured to illuminate the microfluidic chip 102 with light in the visible light spectrum. An objective lens 108 collects light from the microfluidic chip 104 and directs the light to a dichroic beam splitter 110.

The beam splitter 110 is configured to reflect a first portion of light from the beam splitter 110 to a photodetector 112. The beam splitter 110 is configured such that a second portion of light is transmitted from the beam splitter 110 to a high-speed camera 116.

In this example, the LED 104 is a white LED, and the beamsplitter 110 is a dichroic mirror that splits an in-focus image of the flow of droplets into light portions above or below a predetermined wavelength (in this example, the wavelength is 488 nm such that blue light is directed to the photodetector). The beam splitter 110 directs approximately 20% of the light to the photodetector and 80% to the camera, however the split-ratio may be altered. The camera has a lower sensitivity in the blue region of visible light than the red and green regions of visible light, and so the dichroic mirror directs the green and red portions of visible light to the camera to improve sensitivity. The blue light is directed to the photodetector.

Light having a wavelength below the predetermined wavelength (in this example, 488 nm) is reflected by the dichroic mirror 110 to a photodetector 112. An aperture 114 is located between the beam splitter 110 and the photodetector 112. The aperture 114 can be a mechanically adjustable slit (referred to as a slit-iris), a circular iris, a narrow rectangular aperture, or a crescent shaped aperture, that is set such that it allows only a narrow band of light from the main microfluidic channel to reach the photodetector.

Each droplet within the flow of droplets includes a first liquid droplet suspended in a carrier fluid. The droplet liquid may be a particle in an aqueous liquid and the carrier fluid may be a continuous oil phase. When the interface between the droplet and the carrier fluid passes over the photodetector 112, the voltage signal of the photodetector diminishes due to the light scattering. Once, the droplet has passed over the detector 112 and only the oil continuous phase is visible to the photodetector 112 the voltage increases and returns to the background signal. Each passing picodroplet within the microfluidic channel exhibits a decrease in the amplitude of the photodetector measured voltage signal, as the light intensity is momentarily scattered by the passing droplet. The incidence and repetition of such voltage decreases, which are each characteristic of the presence of individual flowing droplets, over time (i.e., 1 s time-scale) are then used to calculate droplet frequency. This arrangement increases the detection sensitivity of the photodetector and enables measurement of the droplet generation frequency continuously in real-time using custom, automated frequency detection software.

The light having a wavelength above the predetermined wavelength (in this example, 488 nm) is transmitted through the dichroic mirror 110 to the sensor of a high-speed area scan camera 116. To ensure that droplets are imaged at approximately the same area within the microfluidic channel, the photodetector voltage signal output is received and processed on a microprocessor. Upon receiving the photodetector voltage signal output, the microprocessor sends a trigger-signal to prompt camera image acquisition of a picodroplet using ultrashort exposure imaging. For example, when a passing picodroplet causes a decrease in the measured voltage signal amplitude which exceeds a custom-specified threshold, a software process is triggered which firstly waits a set delay time before triggering the acquisition of an image by the camera which has an exposure time of 1 us or less.

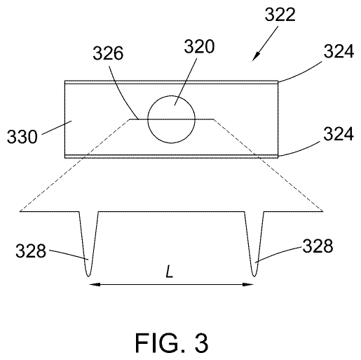

Using an automated software process, which commences after an automated droplet startup procedure is complete, the channel sidewalls and the centre of drops contained in a camera image are detected, in order to define a region of interest (ROI) in captured images of droplet, such as that shown in FIG. 3. The use of an automated, software-based method of defining an ROI removes a significant amount of error that would normally be associated with the manual positioning of the ROI from a human user and thus increases the precision of the droplet size estimation method, and improves confidence in measured values between different experiments.

FIG. 3 illustrates schematically a region of interest in a captured image of a droplet 320 within a microfluidic channel 322. The region of interest 326 is a line region substantially parallel to the sidewalls 324 of the microfluidic channel 322 and including the centre of the droplet. The region of interest 326 will have two negative peaks 328 corresponding to the front and back boundaries of the droplet 320, where light is scattered at the interface between the droplet 320 and a carrier fluid 330. The distance/extending between the peaks 328 corresponds to the diameter of the droplet 320.

The ROI 326 may be defined in the form of a one-pixel high horizontal line, which is parallel to the microchannel sidewalls 324 and which horizontally intersects imaged picodroplets 320 through their respective centres. The use of only a one-pixel high line of image data, rather than a full image, significantly reduces processing time and thus increases the possible throughput of the system.

Image data from a first defined horizontal line ROI 326 is subtracted from the average of the same data, to make any above average differences detectable in downstream image processing. This processed data is then analysed using peak detection software to identify, for each imaged picodroplet 320, two negative peak minima 328 which relate to the picodroplet front and back boundaries, as shown in FIG. 3, and which are above a specified threshold that is selected to filter out any differences caused by biological cells/objects encapsulated within the droplets. The peak-to-peak distance or length (l) is then a measure of the diameter of the detected picodroplet 320, from which droplet volume can be estimated.

Image data from the ROI may also be processed using a different set of applied thresholds, which when subtracted from the average of the same data, can be used to identify the position, number, size and/or morphology of contained biological cells or objects within droplets.

The microfluidic channel may include a marker having known dimensions (not shown). The captured image may include the droplet and the marker, and then a dimension of the droplet within the captured image can be compared with the marker located within or in a region located close to the microfluidic channel to determine the physical droplet dimension. This may be performed in combination with determining an ROI or may be used instead of determining peaks from an ROI.

The optical assembly may be provided as an inverted microscope, such as that shown in FIG. 2. The inverted microscope can be a semi-automated inverted microscope with white LED illumination, in which images of a microfluidic chip mounted on an x,y-translatable stage 218 can be continuously and simultaneously relayed to a silicon free-space amplified photodetector and a high-speed area scan camera. The translatable stage 218 may also be rotatable (0). The LED is mounted in a LED holder 204 that is adjustable in the z-direction. The objective lens 208 in the inverted microscope shown in this example is adjustable along the z-axis to allow an image of the microchip to be formed by a lens 232. In this example, the lens 232 has a focal length of 100 mm. The microfluidic chip can be a droplet generation chip as shown in FIGS. 4 to 7, including the output or collection channel of a microfluidic droplet generation and biological cell/particle encapsulation. The system enables downstream signal processing and subsequent regulation of the monodispersity of a produced emulsion containing picodroplets.

The instrument can be semi-automated; a human user may assemble a microfluidic chip to the macrofluidic connections and place the assembled fixture upon the instrument stage before navigating through the sequential, automated steps of the custom software-based workflow operations.

FIG. 4 illustrates schematically a droplet generation region 440 on a microfluidic chip that may be used with the optical assembly of FIG. 1. FIG. 4 shows a view of a single-dispersed phase inlet droplet generation region having Y-shaped sorting channels leading to the waste and/or collection channels. The droplet generation region includes an aqueous sample inlet channel 442 and a carrier oil inlet channel 444 for generating the emulsion. Flows of these liquids are provided to a flow focus junction 446 where the emulsion is generated and provided to a collection channel 448 of the droplet generation region 440. The aqueous inlet fluid is encapsulated in immiscible fluorous sheath oil at the flow-focus junction 446 to produce water-in-oil picodroplets. By way of example, to provide some illustrative numbers, the carrier oil may have a flow rate of 1400 μl per hour, the aqueous sample, for example a cell suspension, may have a flow rate of 1000 μl per hour and the water-in-oil emulsion in the collection channel may have a flow rate of 2400 μl per hour comprising 700 picolitre droplets at 1000 Hz.

The sample inlet channel 442 is coupled to a first pressure controller (not shown) and the carrier fluid inlet channel 444 is couple to a second pressure controller (not shown). The first and second pressure controllers can be used to control the pressure within the sample fluid inlet channel 442 or the carrier fluid inlet channel 444.

In this example, the sample and carrier fluids for each of the continuous and dispersed phases are delivered to the aqueous sample inlet channel 442 and a carrier oil inlet channel 444 via flexible tubing which is connected to a gas pressurized fluid reservoir, which in turn is actuated via a fast-acting pressure regulator. Upon automated software adjustment of the objective focus (z-direction) level via its associated stepper motor, an automated droplet production start-up software process is subsequently used to increase the pressure controlling the fluid flow of both aqueous sample inlet channel 442 and a carrier oil inlet channel 444 in order to begin droplet production.

The calculated droplet size, as discussed above in relation to FIG. 3, can be used as the input to a feedback loop, which regulates the input pressure of one or more fluidic inlet lines 442, 444 in response to the calculated droplet size to maintain the monodispersity of the droplets within the emulsion.

A system, including the optical assembly shown in FIG. 1 having a microfluidic chip including the droplet generation region of FIG. 4, may perform an automated process of the steps discussed above to use photodetector-based detection of the presence of individual droplets in a microfluidic flow to initiate the triggered capturing of droplet images at a specified area within the microfluidic channel. The images may be used to then calculate average or individual droplet size and input the calculated droplet size data into a closed feedback loop that maintains the monodispersity of a single emulsion by controlling the pressure of the sample fluid inlet channel 442 or the carrier fluid inlet channel 444 in response to the calculated droplet size data.

A closed-loop image-based feedback routine is then initiated, whereby image data from the ROI is taken from sequential images and processed, as described previously, to measure droplet size and subsequently regulate the input pressure(s) of one or more input fluid lines to maintain droplet monodispersity within an emulsion over the duration of the emulsion production run.

The product of average frequency during a given period of image acquisition and the average droplet volume during the same period is a good approximation of the volume of sample consumed in the droplet, the sum of which can be continuously updated. Using the determined average picodroplet volume and the photodetector-derived average picodroplet generation frequency, then the volume of droplets within the produced emulsion can be calculated. When the volume of produced emulsion is equal to or exceeds a user-specified target volume, automated software is initiated which increases the pressure of the carrier oil inlet channel 444 to, firstly, limit further fluid flow from the aqueous sample inlet channel 442 and, secondly, to clear the last produced picodroplets from the microfluidic chip to the emulsion reservoir, to make the produced emulsion physically available to the user. In this way, the user can specify the volume of emulsion that they want to collect, based on the sample size provided and the machine will stop producing the emulsion when this value is achieved.

In a further embodiment, which is a not shown, a microfluidic chip may include a plurality of droplet generation regions similar to those shown in FIG. 4 (for example, the microchip chip could have eight or more droplet producing nozzles, each of which lead into one of eight or more parallel collection channels). An optomechanical arrangement may be located immediately after the dichroic beam splitter to send light (having a wavelength <488 nm) from two or more of the independent, parallel channels to independent photodetector detection chips in order to trigger droplet imaging and also to gather frequency data independently from two or more of the parallel channels. The image processing method described above, for identifying the sidewalls of a microchannel and the centre of produced droplets, and defining a horizontal-line ROI which is parallel to the containing microchannel sidewall, is used but is scaled up such that a minimum of two of the eight or more parallel channels has an independent ROI defined upon it by image processing. The droplet size data from each independent ROI is used to extract droplet size data from multiple channels, which in turn is used to regulate the closed-loop image-based feedback regulation of the input pressures influencing droplet size. This provides parallelized single emulsion droplet generation with closed-loop image-based feedback.

In a further embodiment, which is not shown, the parallel collection channels can each subsequently converge into a common downstream outlet channel. An optomechanical arrangement may be located after the dichroic beam splitter to send light (having a wavelength <488 nm) from the common downstream outlet channel (to which each of the upstream, parallel channels has merged into) towards one or more independent photodetector detection chip(s) in order to trigger droplet imaging and also to gather frequency data. The image processing method described above, for identifying the sidewalls of a microchannel and the centre of produced droplets, and defining a horizontal-line ROI which is parallel to the containing microchannel sidewall, is used such that the common outlet channel may have one or more independent ROI defined upon it by image processing.

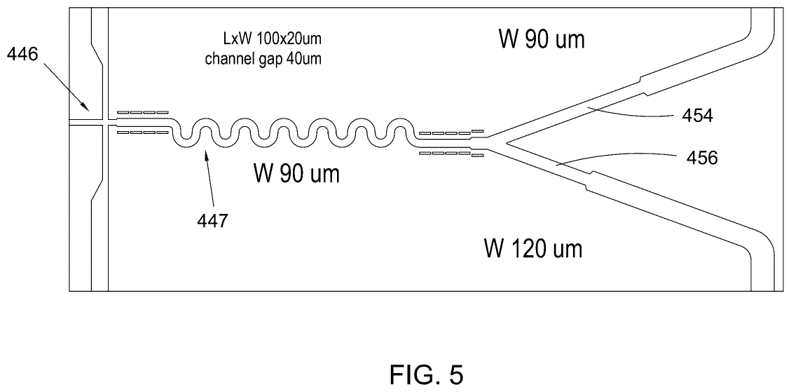

The flow focus junction 446 is also coupled to a waste channel 452, as shown in FIGS. 4, 5, 6, and 7. FIG. 5 shows a flow focus junction 446, a serpentine channel 447, and a Y-shaped sorting junction with channels 454, 456, leading to both waste 452 and collection 448 within the droplet generation region of FIG. 4. The emulsion formed at the flow focus junction 446 flows through a serpentine channel 447, and to a Y-junction having two outputs 454, 456. When the instrument is started-up, there may be a period of time where the droplets that are being generated do not meet the specified user's size requirements. Generally, this may be a period of ten or more seconds. The serpentine channel 447 is a sinusoidal shape channel, and this mixes the contents of the droplets by inducing a tumbling effect within the droplets as they traverse the serpentine channel 447. In the example shown, the serpentine channel 447 has a width of 90 μm.

The first output 454 has a narrower width and is located between the flow-focus junction 446 and the collection channel 448. The second output 456 has a larger width and is located between the flow-focus junction 446 and the waste channel 452. In the example shown, the first output 454 has a width of 90 μm and the second output has a width of 120 μm. Whilst the droplets that are being generated do not meet the specified user's size requirements, this microfluidic chip would allow these droplets to travel to the waste channel 452, and only when the correct droplet size is achieved would a memory shape valve (not shown) on the waste channel 452 be closed. In an example, the valve has been programmed to shut over a period of 1 second, but the rate of closure can be changed. By closing the valve of the waste channel 452 relatively slowly, this allows the system to compensate for the increased back pressure in the system without the droplet volume changing.

In this example, the sample fluid inlet 442 and the carrier fluid inlet 444 are spaced relatively far apart from each other and from the collection and waste channels 448, 452. This allows a cell or oil sample reservoirs, such as syringe bodies, to be mounted directly to the chip using Luer-Lock fittings.

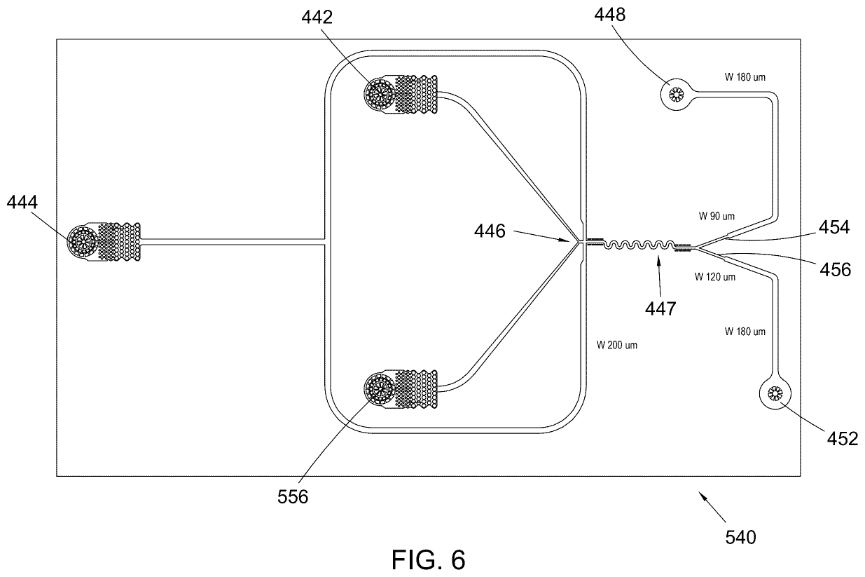

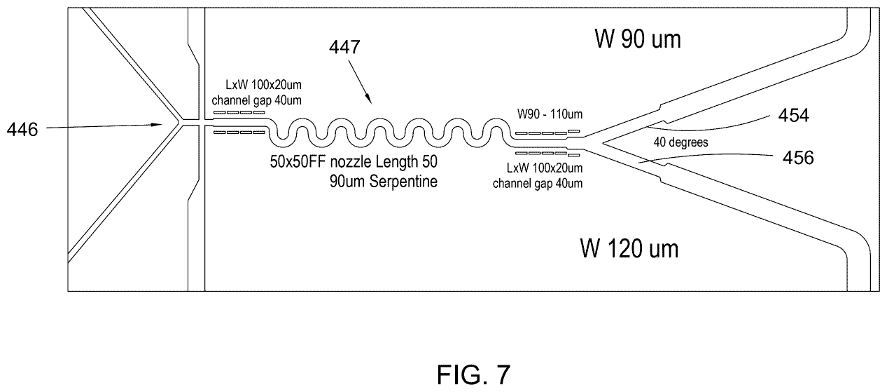

FIG. 6 illustrates schematically a droplet generation region 540 for dual-aqueous emulsion generation. FIG. 6 shows a view of a dual-dispersed phase droplet generator-sorting chip design for producing an emulsion of dual dispersed phase droplets and FIG. 7 shows the flow focus junction 446, the serpentine channel 447, the Y-shaped sorting junction with channels 454, 456 leading to both waste 452 and collection 448 of the droplet generation region 540 of FIG. 6.

The serpentine channel region 447 is a sinusoidal shape channel located between the flow focus junction 446 and the Y-junction. This aids droplet mixing of the dual-dispersed phase mixture within the droplets.

Dual-aqueous droplets are droplets formed of a mixture of two aqueous fluids. The fluids may both comprise sample fluids, or one of the fluids may be a sample fluid and the other fluid used to dilute the sample fluid of the mixture within the droplets. The droplet generation region 440 is similar to that shown in FIG. 4, however the droplet generation region also includes a second sample fluid inlet 556. The two laminar aqueous inlet fluids can converge just prior to the flow focus junction 446 and are encapsulated in immiscible fluorous sheath oil at the droplet-producing nozzle to produce individual water-in-oil picodroplets. A third pressure controller 558 is used to control the pressure of fluid flow within the second sample fluid inlet 556 from an additional reservoir containing a second aqueous sample.

A liquid flow sensor (not shown) is placed to measure the flow along one or more of the aqueous inlets 442, 556. By measuring the total aqueous sample flow rate for a minimum of one of the aqueous inlet lines, the calculated average droplet volume, and the droplet frequency, then the mixture ratio between the two aqueous inlet samples within the formed droplets can be estimated in real-time. This is performed by
(i) multiplying the picodroplet droplet frequency (also referred to as the droplet generation rate) by the calculated rolling average picodroplet volume to calculate the total volumetric flow rate of the system (e.g., in units μL s⁻¹), and;
(ii) subtracting the measured sensor-based volumetric flow rate of one aqueous inlet line 442, 556, measured using the flow sensor, and
(iii) calculating the following ratio: flow-sensor based volumetric flow rate of a single aqueous inlet line/(total volumetric flow rate of the system-flow-sensor based volumetric flow rate of a single aqueous inlet line).

The first and third pressure controllers can be used to control the pressure within the sample fluid inlets 442, 556 in response to the estimated mixture ratio within the formed droplets. This allows the mixture ratio of the two sample fluids within the droplets to be regulated in real-time. This provides a closed-loop image-based feedback routine, to produce a monodisperse single emulsion of aqueous picodroplets in a fluorous oil-based encapsulating fluid with a user-defined mixture ratio between the two inlet aqueous fluids and a user-defined picodroplet volume. Further, the mixture ratio can be maintained at a constant level, or the mixture ratio can be defined to change over a certain time period.

Image analysis from the ROI in an image of a produced picodroplet may be used to count the number of contained microparticles (including biological cells) within each individual picodroplet. The average biological cell/object-occupancy of droplets may be monitored. The first and third pressure controllers can be used to control the pressure within the sample fluid inlets 442, 556 in response to the average biological cell/object-occupancy of droplets. In this way, the device provides a closed-loop feedback system, where the average biological cell/object-occupancy of droplets is used as the input to the feedback loop to regulate the mixture ratio between the two inlet aqueous fluids (for example, a first aqueous sample fluid may be a particle or cell-laden solution and the second aqueous sample fluid may be a compatible buffer solution). Adjustment of this mixture ratio allows the average particle or cell occupancy to be controlled during an experimental run to compensate for particle or cell sedimentation, high particle or cell concentration, or other forms of drift.

### Droplet Fusion

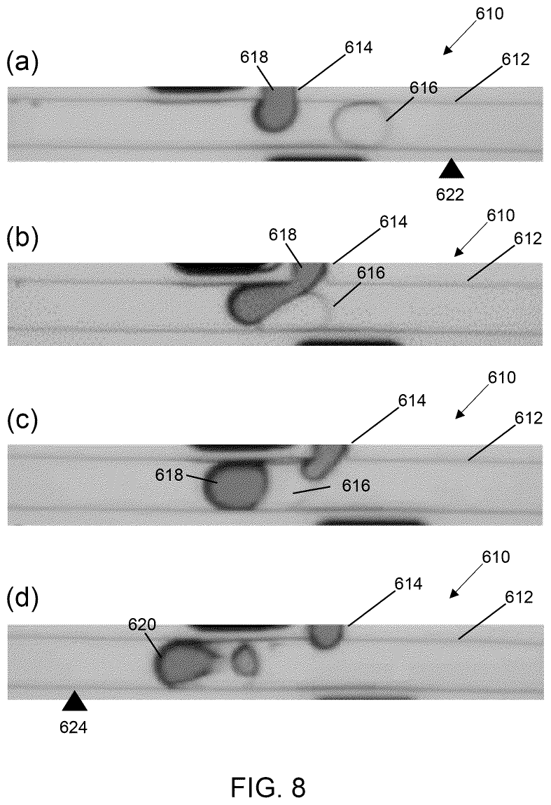

FIG. 8 shows an example droplet fusion region 610. The droplet fusion region 610 may be part of a microfluidic chip that could be used with the optical assembly of FIG. 1. The droplet fusion region 610 includes a microfluidic droplet channel 612 for carrying a flow of an emulsion of microdroplets 616 in a carrier fluid. The droplets arrive at a first end or first input of the microfluidic channel 612. A droplet fluid inlet 614 is located downstream of the first input and provides a flow of droplet fluid 618 to the microfluidic droplet channel 612. In the example shown in FIG. 8, the droplet fluid inlet 614 is provided as a second microfluidic channel provided substantially perpendicular to the microfluidic droplet channel 612.

A first droplet sensor 622 is located upstream of the droplet fusion region 610 and detects and determines a droplet volume of individual droplets 616 within the flow of emulsion. A second droplet sensor 624 is located downstream of the droplet fusion region and detects either the volume of the fused droplets 620. The first and second droplet sensors 622, 624 may each comprise an optical assembly such as that shown in FIGS. 1 and 2. The volume of the droplets may be determined using methods described in relation to droplet generation, such as those used in connection with the microfluidic chips shown in FIGS. 4 to 7.

A pressure or flow rate of the droplet fluid 618 in the droplet fluid inlet 614, or a pressure or flow rate of the emulsion within the microfluidic channel 612, can be increased or lowered based on the measured droplet volumes in a closed-loop feedback method, in order to ratio of fluids within fused droplets 620.

The droplet fusion region 610 may be placed downstream of the droplet generation region 440, 540 shown in FIGS. 4 to 7, and the droplets generated by the droplet generation region 440, 540 may be input into the droplet fusion 610.

The droplet fusion region 610 can be used to fuse a droplet 616 formed of a first droplet fluid within an emulsion, with a second droplet fluid 618 to form an emulsion of fused droplets 620 each containing a mixture of the first droplet fluid and the second droplet fluid. The image-based closed-loop feedback can be used to alter the ratio of the mixture of the first droplet fluid and the second droplet fluid within the fused droplets, to allow the ratio to be adjusted or held at a substantially constant, optimal value.

An example method of fusing droplets 616 with a second droplet fluid 618 using the droplet fusion region 610 is as follows, with the steps performed in the order as below:
(1) providing a flow of emulsion including a stream of dispersed microfluidic droplets 616 of a first droplet fluid within a continuous fluid phase to the microfluidic channel 612;
(2) imaging the droplets 616 flowing in the microfluidic channel 612 using a droplet sensor 622 provided in a droplet detection region;
(3) calculating a droplet 616 size or volume from the captured image. Alternatively, the droplet size or volume may be known or obtained using an alternative method. For example, droplet volume can be calculated without imaging the droplets, if the total volume of input droplets 616 is known and the droplets are monodispersed or of uniform size;
(4) the emulsion flows through the microfluidic channel 612 towards the droplet fluid inlet 614;
(5) introducing a second droplet fluid 618 into the microfluidic channel 612 from a droplet fluid inlet 614 such that a body of second droplet fluid 618 extends from the droplet fluid inlet 614 into the microfluidic channel 612, as shown in FIG. 8(a);
(6) as the emulsion further flows through the microfluidic channel 612 there is a point of physical contact or collision between a droplet 616 and the second droplet fluid 618, as shown in FIG. 8(b). The point of physical contact or collision is in a region of the microfluidic channel 612 adjacent to the droplet fluid inlet 614;
(7) fusing the droplets 616 and the second droplet fluid 618 The presence of a method of fusing the fluids at the collision point disrupts the structures of the fluid boundaries of both the droplet of the first fluid 616 and the protruding body of the second droplet fluid 618, causing them to fuse or mix into a single body of fluid protruding from the droplet fluid inlet 614, as shown in FIG. 8(c). The two fluids may be fused due to the build of pressure in the microfluidic droplet channel, as discussed in step (8).
   Alternatively, the disruption of fluid boundaries of the droplet of the first fluid and the second fluid can be induced by external stimuli leading to coalescence. External stimuli can be electrical or optical. Electro-coalescence involves fusing droplets by applying an electric field when the droplets pass through a confined region bounded by a pair of electrodes. An optical method involves using a focused laser beam to locally heat up the fluid boundary, and thus, change the surface tension of the droplet interfaces.
   In FIG. 8(c), the fluid of the single body of fluid protruding from the droplet fluid inlet 614 into the microfluidic channel 612 includes a mixture of both the first droplet fluid and the second droplet fluid;
(8) as emulsion upstream of the droplet fluid inlet 614 continues to flow towards the droplet fluid inlet 614, there is an increase in pressure of the emulsion behind single body of fluid protruding from the droplet fluid inlet 614. This build-up of stress or pressure behind the protruding body of fluid leads to the breakup of a fused microdroplet 620 from the droplet fluid inlet 614, as shown in FIG. 1(d). This fused droplet 620 can be a dual-aqueous droplet and includes a mixture of the first droplet fluid and the second droplet fluid, and will continue to flow downstream as part of a flow of an emulsion of fused droplets;
(9) imaging the fused droplets 620 flowing in the microfluidic channel 612 using a droplet sensor 624 provided in a second droplet detection region downstream of the droplet fluid inlet 614;
(10) calculating a droplet size or volume from a captured image of a fused droplet 620;
(11) determining a change in volume between the initial microdroplet 616 and the fused droplet 620 using the images captured using the droplet sensors 622, 624, and calculating the volumetric contributions from the first droplet fluid and the second droplet fluid fluids or the ratio of the first droplet fluid and the second droplet fluid within each droplet in the flow of fused droplets.

The calculated volume or size values from the images captured by the first droplet sensor 622 and the second droplet sensor 624 in steps (4) and (10), or the ratio of the first droplet fluid and the second droplet fluid calculated in step (11) can be used as an input to a closed-loop feedback routine. In this, the experimental inputs (e.g., driving pressure, or flow rate) of the flow of emulsion provided to the microfluidic channel or the flow of second droplet fluid provided in the droplet fluid inlet are regulated in response to the calculated volumes or ratio, in order to maintain droplet parameters at a pre-determined level (e.g., final fused droplet volume, volumetric contributions, fluid ratio) when generating a flow of an emulsion of fused droplets 620. It can be simpler to control the ratio of first droplet fluid and second droplet fluid by fusing a microdroplet of a first droplet fluid with a second droplet fluid rather than mixing two droplet fluids prior to generating the droplets.

For example, the image-based closed-loop feedback routine can regulate and maintain the droplet volume of droplets 616 within the initial emulsion of droplets by altering the driving force of the first fluid flow. This is because, the flow rate of the droplet of the first fluid will affect the time interval of the collision of the droplet with the protruding component of the second fluid, and thus the amount of the second fluid mixing with the droplet. If the flow rate of the droplet is lower, it will have more time keeping in contact with the protruding component of the second fluid and the second fluid will mix more with the droplet. The image-based closed-loop feedback routine can be used to simultaneously adjust the driving force or pressure of the flow of second droplet fluid, in response to the volumetric contributions or ratio of fluids within the droplets of the flow of fused droplets deviating from a pre-determined level.

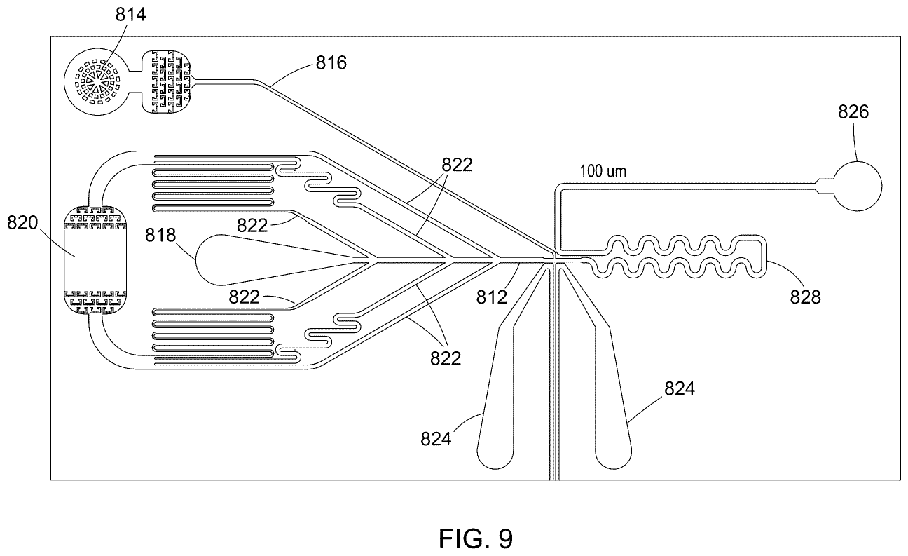

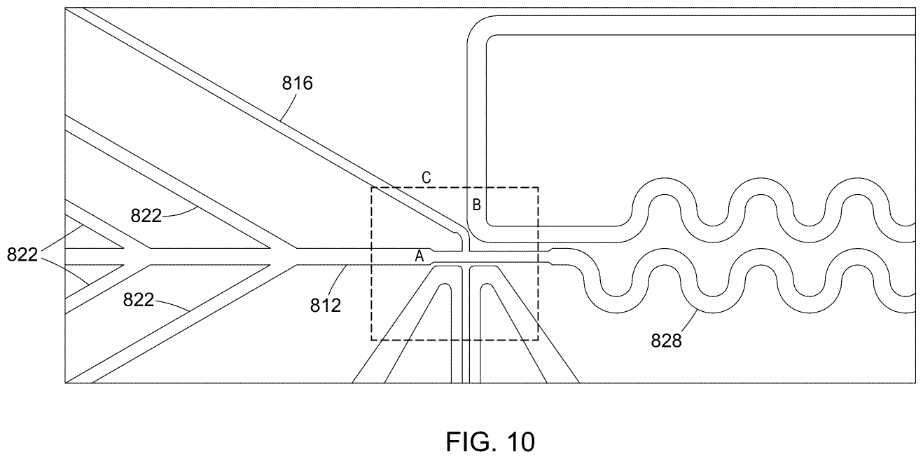

FIG. 9 illustrates schematically a droplet reinjection region and droplet fusion region, and FIG. 10 illustrates schematically the droplet fluid inlet of the droplet fusion region shown in FIG. 9.

The droplet fusion region includes a droplet inlet 818 for providing microdroplets formed in an emulsion comprising a first droplet fluid in an immiscible carrier fluid. The droplet inlet 818 provides droplets to the microfluidic droplet channel 812. Droplets in the microfluidic droplet channel 812 flow towards a junction between the microfluidic droplet channel 812 and a droplet fluid channel 816 through which a second droplet fluid flows towards the microfluidic droplet channel 812 from a droplet fluid inlet 814. The droplet fluid channel 816 is arranged such that it is substantially perpendicular to the microfluidic droplet channel 812 at the junction between the droplet fluid channel 816 and the microfluidic droplet channel 812. Droplets in the microfluidic droplet channel 812 fuse with the second droplet fluid provided from the droplet fluid inlet 814 in the same manner as described in relation to FIG. 8.

In this example, two electrodes 824 (a ground electrode and a live electrode) are located in the vicinity of the junction between the microfluidic droplet channel 812 and the droplet fluid channel 816. An electric field between the two electrodes 824 causes the second droplet fluid to fuse with the microdroplets, as described in relation to FIG. 8.

Fused droplets flow from the microfluidic droplet channel 812 towards a fused droplet outlet 826, through a fused droplet channel 828. In this example, the fused droplet channel 828 has a serpentine shaped portion which facilitates mixing of the first droplet fluid and the second droplet fluid within the fused droplets. The fused droplet channel 828 is shaped such that after mixing, the fused droplets can be imaged in the field of view of the camera.

A camera is provided out of the plane of the system shown in FIGS. 9 and 10, and the camera images a region C such that droplets can be detected at points A and B. As described in relation to FIG. 8, the size of fused droplets or ratio of first droplet and second droplet liquid within fused droplets can be controlled in response to the camera imaging the droplets at locations A and B, by altering the pressure and/or flow rate of droplets from the droplet inlet 818, the second droplet fluid from the droplet fluid inlet 814, or the spacing fluid from the spacing fluid inlet 820.

In this example, a spacing fluid inlet 820 provides spacing fluid to the microfluidic droplet channel 812 through spacing fluid channels 822 arranged on the sidewalls of the microfluidic droplet channel 812, between the droplet inlet 818 and the droplet fluid channel 816. The spacing fluid increases the spacing between droplets in the microfluidic droplet channel 812, allowing the rate at which droplets reach the junction with the droplet fluid channel 816 to be controlled. The reinjection region refers to the droplet inlet 818 and the spacing fluid inlet 820 providing spacing fluid or additional carrier fluid to the microfluidic channel through the spacing fluid channels 822.

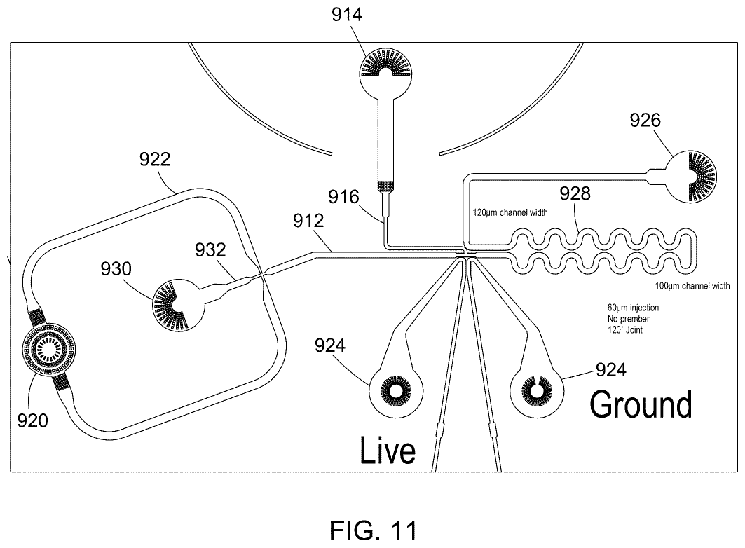

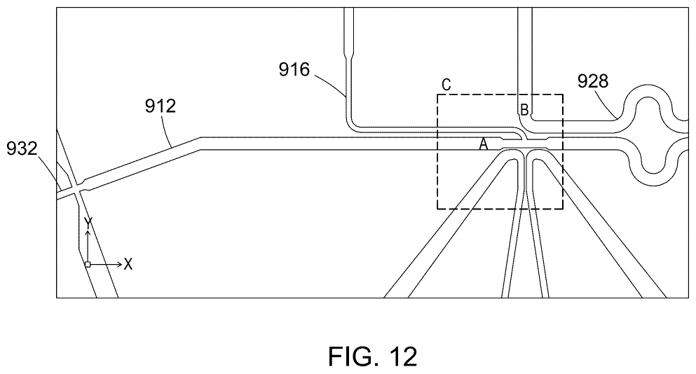

FIG. 11 illustrates schematically a droplet generation region and droplet fusion region, and FIG. 12 illustrates schematically the droplet fluid inlet of the droplet fusion region shown in FIG. 11. The droplet generation region is similar to that shown in FIG. 4. Many of the features are the same as those shown in FIGS. 9 and 10 and therefore carry similar reference numerals.

The droplet generation region includes a first droplet fluid inlet 930 and a carrier fluid inlet 920 which provide a first droplet fluid (such as an aqueous sample) through a first droplet fluid channel 932 and a carrier fluid channel 922. Flows of these liquids are provided to a flow focus junction 946 where an emulsion is generated and provided to a microfluidic droplet channel 912. The aqueous inlet fluid is encapsulated in immiscible fluorous sheath oil at the flow-focus junction 946 to produce an emulsion of water-in-oil picodroplets.

Droplets in the emulsion fuse with a second droplet fluid in the same manner as described in relation to FIGS. 8 to 10. Droplets in the microfluidic droplet channel 912 flow towards a junction between the microfluidic droplet channel 912 and a second droplet fluid channel 916 through which a second droplet fluid flows towards the microfluidic droplet channel 912 from a droplet fluid inlet 914.

The system of FIG. 12 allows the volume of droplets containing only the first droplet fluid to be controlled, such that the ratio of the first droplet fluid and the second droplet fluid within fused droplets can be controlled using the closed-loop feedback by adjusting the pressure and/or flow rate of the first droplet fluid and the carrier fluid and without adjusting the pressure and/or flow rate of the second droplet fluid.

### Droplet Splitting

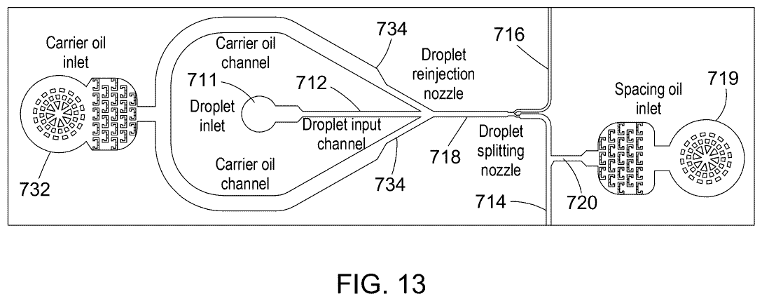

FIG. 13 illustrates schematically a droplet reinjection region and a droplet splitting region. The system includes a droplet inlet 711 for providing microdroplets formed in an emulsion comprising a first droplet fluid in an immiscible carrier fluid. The droplet inlet 711 provides droplets to the microfluidic droplet channel 718, through a droplet inlet channel 712.

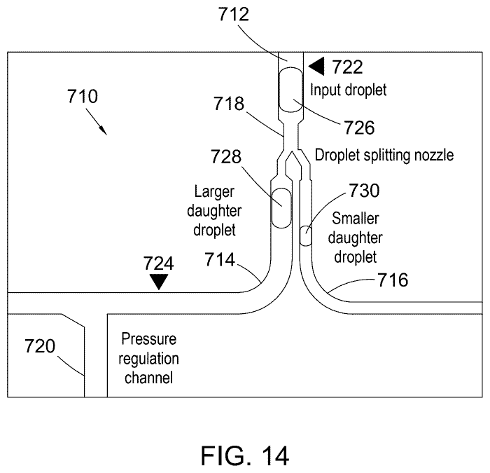

Droplets in the microfluidic droplet channel 718 flow towards a junction between the microfluidic droplet channel 718 and a droplet splitting nozzle, such as that described in relation to FIG. 14.

In this example, a carrier fluid inlet 732 provides additional carrier or spacing fluid to the microfluidic droplet channel 718 through carrier fluid channels 734 arranged on the sidewalls of the microfluidic droplet channel 718, between the droplet inlet 711 and the droplet splitting nozzle. The spacing fluid increases the spacing between droplets in the microfluidic droplet channel 718, allowing the rate at which droplets reach the droplet splitting nozzle to be controlled.

A camera may be provided out of the plane of the system shown in FIG. 13, or the system may include a plurality of sensors such as those shown in FIG. 14. As described in relation to FIG. 14, the size of daughter droplets can be controlled in response to the camera imaging the droplets, by altering the pressure and/or flow rate of droplets from the droplet inlet 711, the additional carrier fluid from the carrier fluid inlet 732, or the spacing fluid from the spacing fluid inlet 720.

The droplet splitting region or droplet splitting nozzle is the same as that shown in FIG. 14, and is described in relation to FIG. 14 below.

FIG. 14 illustrates schematically an example droplet splitting region 710. The droplet splitting region 710 includes a droplet inlet channel 712 for providing a flow of an emulsion of microdroplets 726 in a carrier fluid. The droplet splitting region 710 has two outputs located downstream of the droplet inlet 712 and formed of two daughter droplet microfluidic channels 714, 716. In the example shown, there is a microfluidic droplet channel 718 between the droplet inlet channel 712 and the daughter droplet channels 714, 716. The microfluidic channel 718 splits into the two droplet channels 714, 716 at a single junction causing the larger droplet 726 to split into two smaller droplets 728, 730. The junction where the microfluidic channel 718 divides into the two smaller droplet channels 714, 716 may be a droplet splitting nozzle.

The microfluidic droplet channel 718 may be narrower than the droplet inlet 712. The two droplet channels 714, 716 may have a narrower cross-section closer to the junction with the microfluidic droplet channel 718.

In the example shown, the two daughter droplet channels 714, 716 have unequal cross-sectional widths. The first droplet channel 714 has a larger cross-sectional width than the second droplet channel 716, thereby causing the input droplets 726 to split into unequal droplets 728, 730, with the larger droplet 728 being formed at the first droplet channel 714 and the smaller droplet 730 being formed at the second droplet channel 716.

A first droplet sensor or camera 722 is located upstream of the droplet splitting region 710 or at the droplet inlet 712 and detects and determines a droplet volume of individual droplets 726 within the flow of emulsion. A second droplet sensor or camera 724 is located downstream of the droplet splitting region and detects either the volume of the droplets in the first droplet channel 714 or second droplet channel 716. The first and second droplet sensors 722, 724 may each comprise an optical assembly such as that shown in FIGS. 1 and 2. The volume of the droplets may be determined using methods described in relation to droplet generation, such as those used in connection with the microfluidic chips shown in FIGS. 4 to 7.

A carrier fluid inlet 720 or pressure regulation channel provides carrier fluid to the first droplet channel 714. A pressure or flow rate of the carrier fluid in the carrier fluid inlet 720 can be increased or lowered based on the measured droplet volumes in a closed-loop feedback method, in order to adjust the size of the daughter droplets 728, 730 produced.

Whilst in the example shown, one carrier fluid inlet 720 provides carrier fluid to the first droplet channel 714, alternatively a separate carrier fluid inlet may provide carrier fluid to the second droplet channel 716 instead of or in addition to providing carrier fluid to the first droplet channel 714.

An example method of splitting droplets 726 into two smaller droplets 728, 730 is as follows, with the steps performed in the order as below:
(1) providing a flow of emulsion including a stream of dispersed microfluidic droplets 726 within a continuous carrier fluid to the microfluidic channel 718. The droplets may be provided from a droplet inlet 712;
(2) imaging the droplets 726 flowing in the microfluidic channel 718 using a droplet sensor 722 provided in a droplet detection region. Alternatively, imaging the droplets 726 before flowing to the microfluidic channel 718;
(3) calculating a droplet 726 size or volume from the captured image. Alternatively, the droplet size or volume may be known or obtained using an alternative method. For example, droplet volume can be calculated without imaging the droplets, if the total volume of input droplets 726 is known, the number of droplets or droplet frequency is known, and the droplets are monodispersed or of uniform size;
(4) the emulsion flows through the microfluidic channel 718 towards a junction or droplet divider where the microfluidic channel 718 divides into the two smaller droplet channels 714, 716. This may be a droplet splitting nozzle. As the droplet 726 flows through the junction, the droplet is split into two smaller, daughter droplets 728, 730;
(5) the two smaller droplets 728, 730 flow from the junction through two, separate droplet channels 714, 716 which branch from the microfluidic droplet channel 718. The daughter droplets 728 each flow within an emulsion of droplets in a carrier fluid;
(6) imaging a first daughter droplet 728 in a first droplet channel 714 using a droplet sensor 724 provided in a second droplet detection region downstream of the splitting nozzle. Alternatively, or additionally, the method can include imaging a second daughter droplet 730 in a second droplet channel 716.
(7) calculating a droplet 728 size or volume from a captured image of a first daughter droplet 728;
(8) determining a change in volume between the initial microdroplet 726 and the daughter droplet 728 using the images captured using the droplet sensors 722, 724, and calculating the volumetric distribution or volume ratio among the two daughter droplets 728, 730; and
(9) introducing a carrier fluid to the first droplet channel 714 from a carrier fluid inlet 720 or pressure regulation channel. The carrier fluid may be a spacing oil.

The calculated volume or size values from the images captured by the first droplet sensor 722 and the second droplet sensor 724 in steps (2) and (6), or the ratio of the first daughter droplet 728 volume and the second daughter droplet 730 volume calculated in step (8) can be used as an input to a closed-loop feedback routine. In this, the experimental inputs (e.g., driving pressure, or flow rate) of the flow of emulsion provided to the microfluidic channel 718 or the flow of carrier fluid provided in the carrier fluid inlet 720 are regulated in response to the calculated volumes or ratio, in order to maintain droplet parameters at a pre-determined level (e.g., final daughter droplet volume, volumetric contributions or ratios) when splitting the droplets within a flow of emulsion of microdroplets 726.

For example, the image-based closed-loop feedback routine can regulate the pressure or flow rate of a spacing oil or carrier fluid provided from a carrier fluid inlet 720 to one of the daughter droplet channels 714, 716 in order to increase or decrease the backward pressure provided by the carrier fluid in the daughter droplet channel 714, 716, and the microfluidic channel 718. This regulates or maintains the volume ratio of the daughter droplet volume at a pre-determined level, in response to the determined ratio of droplet volumes deviating from a pre-determined level.

Alternatively, or additionally, further carrier fluid may be introduced in the second droplet channel 716 from a second carrier fluid inlet. The further carrier fluid may be the same fluid or a different fluid to the spacing fluid introduced from the carrier fluid inlet 720. The carrier fluid and the further carrier fluid may be the same fluid or a different fluid to the continuous carrier fluid in which the droplets are provided before splitting.

Both the carrier fluid and the further carrier fluid are miscible with the continuous carrier fluid in which the droplets are provided before splitting, and are immiscible with the dispersed microdroplets.

Whilst the examples shown relates to picodroplets within a microfluidic chip, it will be appreciated that the device is not limited to picodroplets (the volume of which is generally below approximately one thousand or a few thousand picolitres), and is applicable to droplets of other sizes (for example, droplets may be larger or smaller, giving a volume which may be in the range nanolitres to femtolitres).

The examples described relate to emulsions comprising droplets comprising a first fluid dispersed within a second fluid, where the second fluid is immiscible with first fluid. The term fluid may be herein used to refer to a liquid.

We have described techniques which, in preferred embodiments, are applied to processing droplets of a water-in-oil emulsion containing biological entities. In principle however non-biological entities, such as organic or inorganic materials, may be processed in a similar manner. Likewise, the techniques we describe are also in principle applicable to processing droplets of oil in oil-in-water emulsions. In water-in-oil emulsions, the oil forming the carrier fluid or spacing fluid generally comprises a fluorous and/or mineral oil and/or silicone oils and, preferably, a surfactant, for example at around 0.5-5% vol/vol or weight/weight.

No doubt many other effective alternatives will occur to the skilled person. It will be understood that the invention is not limited to the described embodiments and encompasses modifications apparent to those skilled in the art lying within the spirit and scope of the claims appended hereto.

Reference numerals

| | |
|---|---|
| 102 | Microfluidic chip |
| 104 | LED |
| 106 | Optical lens tube assembly |
| 108 | Objective lens |
| 110 | Beam splitter |
| 112 | Photodetector |
| 114 | Iris aperture |
| 116 | High speed camera |
| 204 | z-adjustable LED holder |
| 208 | z-adjustable objective lens |
| 218 | x-y-Θ translatable stage |
| 232 | Lens |
| 320 | Droplet |
| 322 | Microfluidic channel |
| 324 | Sidewall |
| 326 | Region of interest |
| 328 | Light peaks |
| 330 | Carrier fluid |
| 440 | Droplet generation region |
| 442 | Sample fluid inlet |
| 444 | Carrier fluid inlet |
| 446 | Flow focus junction |
| 447 | Serpentine channel |
| 448 | Collection channel |
| 452 | Waste channel |
| 454 | First output |
| 456 | Second output |
| 540 | Droplet generation region |
| 556 | Second sample fluid inlet |
| 610 | Droplet fusion region |
| 612 | Microfluidic droplet channel |
| 614 | Droplet fluid inlet |
| 616 | Microfluidic droplet |
| 618 | Droplet fluid |
| 620 | Fused droplet |
| 622 | Droplet sensor |
| 624 | Droplet sensor |
| 710 | Droplet splitting region |
| 711 | Droplet inlet |
| 712 | Droplet inlet channel |
| 714 | First droplet channel |
| 716 | Second droplet channel |
| 718 | Microfluidic droplet channel |
| 719 | Spacing fluid inlet |
| 720 | Spacing fluid inlet channel |
| 722 | Droplet sensor |
| 724 | Droplet sensor |
| 726 | Microdroplet |
| 728 | First daughter droplet |
| 730 | Second daughter droplet |
| 732 | Carrier fluid inlet |
| 734 | Carrier fluid inlet channel |
| 812 | Microfluidic droplet channel |
| 814 | Droplet fluid inlet |
| 816 | Droplet fluid channel |
| 818 | Droplet inlet |
| 820 | Spacing fluid inlet |
| 822 | Spacing fluid channel |
| 824 | Electrodes |
| 826 | Fused droplet outlet |
| 828 | Fused droplet channel |
| 912 | Microfluidic droplet channel |
| 914 | Second droplet fluid inlet |
| 916 | Second droplet fluid channel |
| 920 | Carrier fluid inlet |
| 922 | Carrier fluid channel |
| 924 | Electrodes |
| 926 | Fused droplet outlet |
| 928 | Fused droplet channel |
| 930 | First droplet fluid inlet |
| 932 | First droplet fluid channel |

1. A method of determining droplet frequency of a flow of microfluidic droplets within a microfluidic droplet channel, the method comprising:
illuminating the flow of microfluidic droplets within the microfluidic droplet channel;
using a beam splitter to split light from the flow of microfluidic droplets into a first portion and a second portion, wherein the first portion comprises light above a predetermined threshold wavelength and wherein the second portion comprises light below a predetermined threshold wavelength;
directing the first portion to a camera;
directing the second portion through an aperture located in front of a photodetector to the photodetector;
processing a signal from the photodetector and determining a droplet frequency from fluctuations in the processed signal.

2. A method according to claim 1, further comprising:
detecting a droplet using the processed signal; and
upon detection of the droplet, simultaneously capturing an image of the droplet using the camera.

3. A method according to claim 2, wherein the method further comprises determining a droplet dimension from the captured image of the droplet; and
optionally further comprising calculating a droplet volume from the determined dimension.

4. (canceled)

5. A method according to claim 3, wherein the method of determining the droplet dimension comprises:
identifying sidewalls of the microfluidic droplet channel and centres of droplets within the image of the flow;
determining an interest region in captured images of droplets, wherein the interest region comprises a line region comprising a droplet centre and wherein the interest region is parallel to the sidewalls; and
determining the droplet dimension by processing the line region of the image; and/or
wherein the method of determining the droplet dimension comprises comparing a dimension of the droplet within the captured image with a marker of a known size and located within the microfluidic channel.

6. (canceled)

7. A method of determining a total volume of fluid within a sequence of droplets within a flow of microfluidic droplets, the method comprising:
determining droplet frequency of the flow of microfluidic droplets within a microfluidic droplet channel using the method of claim 1;
for each droplet within the flow of microfluidic droplets, calculating a droplet volume;
calculating an average droplet volume of the droplets; and
determining a total volume of droplets using the droplet frequency and the average droplet volume.

8. A method of generating a flow of droplets, the method comprising
providing a first droplet fluid;
providing a carrier fluid;
forming an emulsion of droplets comprising the first droplet fluid within the carrier fluid, by providing a flow of said first droplet fluid and a flow of said carrier fluid to a droplet generation region of a microfluidic structure;
determining a total volume of fluid within a sequence of droplets within the emulsion of droplets using the method of claim 7; and
increasing a pressure of the flow of said carrier fluid line in response to a determined total volume of fluid within the sequence of droplets being greater than a predetermined threshold value to inhibit droplet generation.

9. A method of generating a flow of droplets, the method comprising:
providing a first droplet fluid;
providing a carrier fluid;
forming an emulsion of droplets comprising the first droplet fluid within the carrier fluid, by providing a flow of said first droplet fluid and a flow of said carrier fluid to a droplet generation region of a microfluidic structure;
determining droplet dimension of sequential droplets within the emulsion using the method of claim 5; and
adjusting a pressure of the flow of the first droplet fluid and/or a pressure of the flow of said carrier fluid in response to the determined droplet dimension; and
optionally comprising varying a pressure of the flow of the first droplet fluid and varying a pressure of the flow of said carrier fluid upon such that a determined droplet dimension is substantially constant between sequential droplets; and/or
wherein during a starting time period of the method of generating a flow of droplets, the method comprises directing the flow of droplets to a waste channel in response to said determined droplet dimension being outside a predetermined droplet dimension range.

10. (canceled)

11. (canceled)

12. A method of generating a flow of droplets, comprising:
providing a first droplet fluid;
providing a carrier fluid;
providing a second droplet fluid;
forming an emulsion of droplets comprising a mixture of the first droplet fluid and the second droplet fluid within the carrier fluid, by providing a flow of said first droplet fluid and a flow of said second droplet fluid and a flow of said carrier fluid to a droplet generation region of a microfluidic structure;
measuring a flow rate of the flow said first droplet fluid or the flow of said second droplet fluid;
determining a total volume of droplets within the emulsion of droplets using the method of claim 7;
determining a ratio of the first droplet fluid and the second droplet fluid within the mixture using the measured flow rate and the total volume of droplets; and
adjusting a pressure of the flow of the first droplet fluid and/or a pressure of the flow of the second droplet fluid in response to the determined ratio; or
comprising
providing n droplet fluids;
providing a carrier fluid;
forming an emulsion of droplets comprising a mixture of the n droplet fluids within the carrier fluid, by providing a flow of each of the n droplet fluids and a flow of said carrier fluid to a droplet generation region of a microfluidic structure;
measuring a flow rate of n−1 flows of droplet fluids;
determining a total volume of droplets within the emulsion of droplets using the method of claim 7;
determining a ratio of the n droplet fluids within the mixture using the n−1 measured flow rates and the total volume of droplets; and
adjusting a pressure of one or more of the n flows of droplet fluids in response to the determined ratio.

13. (canceled)

14. A microfluidic system comprising:
a microfluidic droplet channel to carry a flow of microfluidic droplets;
a light source to illuminate the flow of microfluidic droplets with a beam of light comprising light having a range of wavelengths both above and below a predetermined threshold wavelength;
a beam splitter configured to split light from the flow of microfluidic droplets into a first portion and a second portion, wherein the first portion comprises light above the predetermined threshold wavelength and wherein the second portion comprises light below the predetermined threshold wavelength;
a camera configured to receive the first portion of the light;
a photodetector configured to receive the second portion of the light, wherein an aperture is located in front of the photodetector;
apparatus configured to process a signal from the photodetector; and
a processor configured to determine a droplet frequency from fluctuations in the processed signal.

15. A microfluidic system according to claim 14, wherein the processor is configured to detect a droplet using the processed signal and wherein the camera is configured to simultaneously capture an image of the droplet upon the detection of a droplet; and
optionally wherein the camera has an exposure time of less than 5 μs; and/or
comprising:
a first droplet fluid line to carry a first droplet fluid;
a carrier fluid line to carry a carrier fluid; and
a droplet generation region having a first input to receive a flow from the first droplet fluid line, having a second input to receive a flow from the carrier fluid line, and having an output to the microfluidic droplet channel, and
wherein the processor is configured to determine an average droplet volume using captured images of droplets, and wherein the processor is configured to determine a total volume of droplets within a sequence of droplets within the flow of microfluidic droplets using the average droplet volume and the droplet frequency, and
wherein the system further comprises means for increasing a pressure in the carrier fluid line in response to a determined total volume of droplets being greater than a predetermined threshold value

16. (canceled)

17. (canceled)

18. A system according to claim 15, comprising:
a first droplet fluid line to carry a first droplet fluid;
a carrier fluid line to carry a carrier fluid; and
a droplet generation region having a first input to receive a flow from the first droplet fluid line, having a second input to receive a flow from the carrier fluid line, and having an output to the microfluidic droplet channel, and
wherein the processor is configured to determine a droplet dimension of sequential droplets using captured images of droplets, and
wherein the system further comprises means for adjusting a pressure in the carrier fluid line or the first droplet fluid in response to the determined droplet dimension; or
comprising:
n droplet fluid lines each configured to carry one of n droplet fluids;
a carrier fluid line to carry a carrier fluid; and
a droplet generation region having n inputs to receive n flows from the n droplet fluid lines, having a further input to receive a flow from the carrier fluid line, and having an output to the microfluidic droplet channel,
such that the droplet generation region forms an emulsion of droplets comprising a mixture of the n droplet fluids within the carrier fluid; and
n−1 flow rate sensors configured to measure a flow rate of n−1 flows of the n flows of droplet fluids,
wherein the processor is configured to determine an average droplet volume using captured images of droplets, and wherein the processor is configured to determine a total volume of droplets within a sequence of droplets within the flow of microfluidic droplets using the average droplet volume and the droplet frequency, and wherein the processor is further configured to determine a ratio of the n droplet fluids within the mixture using the n−1 measured flow rates and the total volume of droplets, and
wherein the system further comprises means for adjusting a pressure of one or more of the n flows of droplet fluids in response to the determined ratio.

19. (canceled)

20. A method according to claim 1, wherein the aperture comprises a slit corresponding to a band of light substantially perpendicular to sidewalls of the microfluidic droplet channel; or
wherein the aperture comprises a pin-hole corresponding to a beam of light positioned substantially in the centre of the microfluidic droplet channel; or
wherein the aperture comprises a crescent aperture configured to increase sensitivity of the photodetector; and/or
wherein the first portion comprises light having a wavelength greater than 488 nm and wherein the second portion comprises light having a wavelength less than 488 nm.

21. (canceled)

22. (canceled)

23. (canceled)

24. A microfluidic method of preparing a droplet, the method comprising:
providing a flow of an emulsion of microfluidic droplets of a first droplet fluid within a carrier fluid in a microfluidic channel;
determining a droplet dimension of a droplet in the flow of microfluidic droplets;
providing a flow of a second droplet fluid to the microfluidic channel;
fusing the droplet of the first droplet fluid with at least a portion of the second droplet fluid to obtain a fused droplet;
determining a droplet dimension of the fused droplet;
adjusting a pressure or flow rate of the flow of the emulsion of microfluidic droplets and/or a pressure or flow rate of the flow of the second droplet fluid in response to the determined fused droplet dimension,
wherein the droplet dimension of the droplet in the flow of microfluidic droplets and/or the droplet dimension of the fused droplet are determined according to the method of claim 3.

25. A microfluidic method of preparing a droplet, the method comprising:
providing a flow of an emulsion of microfluidic droplets of a first droplet fluid within a carrier fluid in a microfluidic channel;
determining a droplet dimension of a droplet in the flow of microfluidic droplets;
providing a flow of a second droplet fluid to the microfluidic channel;
fusing the droplet of the first droplet fluid with at least a portion of the second droplet fluid to obtain a fused droplet;
determining a droplet dimension of the fused droplet;
adjusting a pressure or flow rate of the flow of the emulsion of microfluidic droplets and/or a pressure or flow rate of the flow of the second droplet fluid in response to the determined fused droplet dimension.

26. A method according to claim 24, wherein providing a flow of second droplet fluid comprises providing a flow of second droplet fluid from a fluid inlet arranged on a sidewall of the microfluidic channel; and/or
wherein fusing the droplet of the first droplet fluid with at least a portion of the second droplet fluid to obtain a fused droplet comprises forming a fused droplet comprised of a mixture of the first droplet fluid and the second droplet fluid; and
optionally wherein the method further comprises determining a ratio of the first droplet fluid and the second droplet fluid in the mixture of the first droplet fluid and the second droplet fluid, and wherein a pressure or flow rate of the flow of emulsion or flow of second droplet fluid is adjusted in response to the determined ratio; and/or
wherein fusing the droplet of the first droplet fluid with at least a portion of the second droplet fluid comprises applying an electric field across the droplet of the first droplet fluid and a portion of the second droplet fluid; and/or
wherein providing a flow of an emulsion of microfluidic droplets of a first droplet fluid within a carrier fluid in a microfluidic channel comprises:
providing a first droplet fluid;
providing a carrier fluid;
forming an emulsion of droplets comprising the first droplet fluid within the carrier fluid, by providing a flow of said first droplet fluid and a flow of said carrier fluid to a droplet generation region of a microfluidic structure; and
optionally wherein adjusting a pressure or flow rate of the flow of the emulsion of microfluidic droplets comprises adjusting a pressure of the flow of the first droplet fluid and/or a pressure of the flow of said carrier fluid in response to the determined droplet dimension; and/or
further comprising providing a flow of spacing fluid to the microfluidic droplet channel, and wherein adjusting a pressure or flow rate of the flow of the emulsion of microfluidic droplets comprises adjusting a pressure or flow rate of the flow of spacing fluid in response to the determined droplet dimension.

27. (canceled)

28. (canceled)

29. (canceled)

30. (canceled)

31. (canceled)

32. (canceled)

33. A microfluidic system comprising:
a droplet inlet for providing a flow of an emulsion of microfluidic droplets of a first droplet fluid within a carrier fluid;
a droplet sensing system for determining a dimension of a droplet within the flow of microfluidic droplets;
a fluid inlet for providing a flow of a second droplet fluid;
a droplet fusion region having a first input to receive a flow from the droplet inlet and having a second input to receive a flow from the fluid inlet, and configured to fuse the droplet of the first droplet fluid with at least a portion of the second droplet fluid to obtain a fused droplet;
a second droplet sensing system for determining a dimension of the fused droplet; and
means for increasing a pressure or flow rate of the emulsion within the droplet inlet or the second droplet fluid within the fluid inlet in response to the determined dimension of the fused droplet,
wherein the droplet sensing system or the second droplet sensing system comprise a microfluidic system according to claim 14.

34. (canceled)

35. A microfluidic system according to claim 33, wherein the fluid inlet is arranged on a sidewall of the microfluidic channel; and
optionally wherein the fluid inlet is substantially perpendicular to the microfluidic channel; and/or
wherein the droplet fusion region comprises means configured to fuse the droplet of the first droplet fluid with at least a portion of the second droplet fluid; and
optionally wherein the means configured to fuse the droplet of the first droplet fluid with at least a portion of the second droplet fluid comprises a plurality of electrodes configured to provide an electric field across the droplet of the first droplet fluid and a portion of the second droplet fluid; and/or
further comprising:
a first droplet fluid line to carry a first droplet fluid;
a carrier fluid line to carry a carrier fluid; and
a droplet generation region having a first input to receive a flow from the first droplet fluid line, having a second input to receive a flow from the carrier fluid line, and having an output to the microfluidic droplet channel; and/or
further comprising a spacing fluid line configured to provide a flow of spacing fluid to the microfluidic droplet channel.

36. (canceled)

37. (canceled)

38. (canceled)

39. (canceled)

40. (canceled)

41. A microfluidic method of forming a pair of microdroplets comprising:
providing a flow of an emulsion of microfluidic droplets of a droplet fluid within a carrier fluid in a microfluidic channel;
determining a droplet dimension of a droplet in the flow of microfluidic droplets;
splitting the droplet into a first droplet and a second droplet;
directing the first droplet to a first droplet channel;
directing the second droplet to a second droplet channel;
determining a droplet dimension of the first droplet or the second droplet;
providing a flow of a spacing fluid to the first droplet channel or the second droplet channel; and
adjusting a pressure or flow rate of the flow of the emulsion of microfluidic droplets and/or a pressure or flow rate of the flow of spacing fluid in response to the determined dimension of the first droplet or the second droplet,
wherein the droplet dimension of the droplet in the flow of microfluidic droplets and/or the droplet dimension of the first droplet and/or the droplet dimension of the second droplet are determined according to the method of claim 3.

42. (canceled)

43. A microfluidic method of forming a pair of microdroplets according to claim 41, wherein the method comprises determining a droplet volume of one of the first droplet or the second droplet and further comprises calculating a droplet volume of the other of the first droplet and the second droplet using the previously determined droplet volume of the first droplet or the second droplet and a predetermined volume of the droplet in the flow of microfluidic droplet.

44. (canceled)

45. A microfluidic system comprising:
a droplet inlet for providing a flow of an emulsion of microfluidic droplets of a droplet fluid within a carrier fluid
a droplet sensing system for determining a dimension of a droplet within the flow of microfluidic droplets;
a droplet splitting region having a first input to receive a flow from the droplet inlet and having a first output to a first droplet channel and having a second output to a second droplet channel, wherein the droplet splitting region is configured to split a droplet in the flow of microfluidic droplets into a first droplet and a second droplet;
a fluid inlet for providing a flow of spacing fluid to the first droplet channel or the second droplet channel;
a second droplet sensing system for determining a dimension of the first droplet or the second droplet; and
means for increasing a pressure or flow rate of the emulsion within the droplet inlet or the spacing fluid within the fluid inlet in response to the determined dimension of the first droplet or the second droplet,
wherein the droplet sensing system or the second droplet sensing system comprise a microfluidic system according to claim 14.

46. (canceled)

47. A microfluidic system according to claim 45, wherein the first droplet channel and the second droplet channel have different cross-sectional areas; and/or
further comprising a spacing fluid line configured to provide a flow of spacing fluid to the droplet inlet.

48. (canceled)

49. (canceled)

50. A system according to claim 14, wherein the aperture comprises a slit corresponding to a band of light substantially perpendicular to sidewalls of the microfluidic droplet channel; or
wherein the aperture comprises a pin-hole corresponding to a beam of light positioned substantially in the centre of the microfluidic droplet channel; or
wherein the aperture comprises a crescent aperture configured to increase sensitivity of the photodetector; and/or
wherein the first portion comprises light having a wavelength greater than 488 nm and wherein the second portion comprises light having a wavelength less than 488 nm.
